(19) United States
(12) Patent Application Publication
(10) Pub. No.: US 2026/0328494 A1
(43) Pub. Date: Oct. 22, 2026

(54) GYROID HEAT EXCHANGER SYSTEM WITH INTERNAL DIVIDERS FOR CROSS-COUNTER FLOW

(71) Applicant: DENSO International America, Inc., Southfield, MI (US)

(72) Inventor: Thomas Kolpasky, Madison Hts., MI (US)

(21) Appl. No.: 19/576,844

(22) Filed: Mar. 24, 2026

Related U.S. Application Data
(60) Provisional application No. 63/790,409, filed on Apr. 17, 2025.

(51) Int. Cl. F28F 3/04; F28F 9/02; B33Y 80/00

(52) U.S. Cl. CPC F28F 3/048; F28F 9/0246; B33Y 80/00; F28F 2210/02; F28F 2250/108

(57) ABSTRACT

A heat exchanger is disclosed in which a gyroid core defines first and second non-mixing flow domains separated by a continuous interfacial surface. A first inlet and a first outlet are fluidly coupled to the first flow domain, and a second inlet and a second outlet are fluidly coupled to the second flow domain. Internal dividers are disposed within the gyroid core and partition at least one of the flow domains into a plurality of branches that route fluid along serpentine paths. The internal dividers and port placement are arranged such that flow in the first and second flow domains has opposed directional components across corresponding portions of the interfacial surface to provide cross-counter flow heat exchange. The divider arrangement promotes more uniform flow distribution and increased use of available heat-transfer area within the gyroid core.

### CROSS-REFERENCE TO RELATED APPLICATION

This application claim the benefit of U.S. Provisional Application No. 63/790,409 filed Apr. 17, 2025, titled “GYROID HEAT EXCHANGER DIVIDER”, the entire disclosure of which is incorporated by reference herein.

### TECHNICAL FIELD

The present disclosure generally relates to heat exchanger technologies. In specific embodiments, the present disclosure relates to gyroid-based heat exchangers with internal dividers for enhanced counter-flow heat transfer.

### BACKGROUND

Heat exchangers are widely used in thermal management systems to facilitate the transfer of heat between two fluid streams. Conventional heat exchanger designs often rely on arrangements of tubes and fins to maximize surface area and promote efficient heat transfer. As manufacturing technologies have advanced, new approaches have emerged that utilize complex internal geometries to further increase surface area and improve thermal performance. Additive manufacturing, in particular, has enabled the creation of intricate structures such as triply periodic minimal surfaces, which offer enhanced surface-to-volume ratios within compact volumes.

More recently, gyroid-based structures have been explored for use in heat exchangers due to their distinct geometric characteristics and potential for enhanced heat transfer. These structures enable the separation of fluid domains and can be adjusted to improve flow paths and surface area. Computational modeling and bench testing are frequently utilized to assess the performance of such advanced heat exchanger designs, offering valuable information on flow distribution, pressure drop, and thermal gradients.

Despite these advances, significant challenges remain in achieving uniform fluid distribution and efficient heat exchange throughout complex internal geometries. Existing solutions often struggle to maintain consistent flow across all regions of the heat exchanger, leading to areas of reduced thermal performance. Attempts to improve flow uniformity – such as the addition of internal baffles or variable pore sizing – can introduce undesirable pressure losses or complicate the manufacturing process. Furthermore, discrepancies between computational predictions and empirical results may arise due to limitations in modeling phase-change phenomena or accurately capturing real-world boundary conditions.

There is an ongoing need for improved heat exchanger designs that address these challenges without compromising manufacturability or operational efficiency. The limitations of current approaches highlight the importance of continued innovation to achieve reliable, high-performance thermal management in increasingly demanding applications.

### SUMMARY

In an embodiment, a heat exchanger comprises a monolithic gyroid structure defining a continuous interfacial surface that separates two non-mixing flow domains including a first flow domain and a second flow domain, the gyroid structure having a first side face and an opposite second side face and a first end face and an opposite second end face. The heat exchanger further comprises a first inlet and a first outlet fluidly coupled to the first flow domain, a second inlet and a second outlet fluidly coupled to the second flow domain, a first set of internal dividers disposed within the first flow domain and configured to partition the first flow domain into a plurality of first branches extending from the first inlet to the first outlet, and a second set of internal dividers disposed within the second flow domain and configured to partition the second flow domain into a plurality of second branches extending from the second inlet to the second outlet. The first and second sets of internal dividers are arranged such that corresponding first and second branches are arranged across the interfacial surface with flow in opposite directions. The first inlet and the first outlet are positioned relative to the gyroid structure such that a net direction of flow of a first fluid through the first flow domain from the first inlet to the first outlet has a first directional component from the first side face toward the second side face and a second directional component from the first end face toward the second end face. The second inlet and the second outlet are positioned relative to the gyroid structure such that a net direction of flow of a second fluid through the second flow domain from the second inlet to the second outlet has a directional component from the second side face toward the first side face and a directional component from the second end face toward the first end face, thereby providing cross-counter flow heat exchange across the interfacial surface.

In an embodiment, a heat exchanger comprises a gyroid structure defining a continuous interfacial surface that separates a first flow domain and a second flow domain that are fluidly isolated from one another to inhibit mixing of fluids flowing through the first and second flow domains, the gyroid structure having a first side face and an opposite second side face and a first end face and an opposite second end face. The heat exchanger further comprises a first inlet and a first outlet fluidly coupled to the first flow domain, a second inlet and a second outlet fluidly coupled to the second flow domain, a first set of internal dividers disposed within the first flow domain, wherein the first set of internal dividers is configured to inhibit lateral fluid communication within the first flow domain through at least a portion of a thickness of the gyroid structure, and a second set of internal dividers disposed within the second flow domain, wherein the second set of internal dividers is configured to inhibit lateral fluid communication within the second flow domain through at least a portion of the thickness of the gyroid structure. The first inlet and the first outlet are arranged such that a net direction of flow through the first flow domain has a first directional component from the first side face toward the second side face and a second directional component from the first end face toward the second end face. The second inlet and the second outlet are arranged such that a net direction of flow through the second flow domain has a directional component from the second side face toward the first side face and a directional component from the second end face toward the first end face, thereby providing cross-counter flow heat exchange across the interfacial surface.

In an embodiment, a 3D-printed heat exchanger comprises a monolithic gyroid structure defining a continuous interfacial surface that separates two non-mixing flow domains including a first flow domain and a second flow domain, the gyroid structure having a first side face at an extremity of an interior of the heat exchanger and an opposite second side face at another extremity of the interior of the heat exchanger. The heat exchanger further comprises a first inlet and a first outlet fluidly coupled to the first flow domain, a second inlet and a second outlet fluidly coupled to the second flow domain, a first set of internal dividers disposed within the first flow domain, the first set of internal dividers including at least a first internal divider and a second internal divider that are spaced apart from one another, the first internal divider extending inwardly from the first side face toward the second side face and terminating short of the second side face, and the second internal divider extending inwardly from the second side face toward the first side face and terminating short of the first side face such that the first set of internal dividers defines a plurality of first branches in the first flow domain between the first inlet and the first outlet. The heat exchanger further comprises a second set of internal dividers disposed within the second flow domain, the second set of internal dividers including at least a third internal divider and a fourth internal divider that are spaced apart from one another, the third internal divider extending inwardly from the second side face toward the first side face and terminating short of the first side face, and the fourth internal divider extending inwardly from the first side face toward the second side face and terminating short of the second side face, such that the second set of internal dividers defines a plurality of second branches in the second flow domain between the second inlet and the second outlet. The first and second sets of internal dividers are arranged such that at least one of the plurality of first branches is disposed immediately across the interfacial surface from at least one of the plurality of second branches and is configured for counter-flow heat exchange across the interfacial surface.

### BRIEF DESCRIPTION OF THE DRAWINGS

FIG. 1A is a perspective view of a heat exchanger, according to an embodiment.

FIG. 1B is a cross-sectional perspective view of a gyroid heat exchanger with internal dividers for cross-counter flow, according to an embodiment.

FIG. 1C is a perspective view of a gyroid heat exchanger with the outer cover removed to illustrate two distinct fluid flow domains, according to an embodiment.

FIG. 2A is a cross-sectional view of a gyroid heat exchanger showing internal dividers shaping flow paths within a first flow domain, according to an embodiment.

FIG. 2B is a cross-sectional view of a gyroid heat exchanger showing internal dividers shaping flow paths within a second flow domain, according to an embodiment.

FIG. 3 is a cross-sectional view of a gyroid heat exchanger illustrating internal dividers configured to establish cross-counter flow between two non-mixing fluid domains, according to an embodiment.

FIG. 4 is a velocity magnitude visualization of flow distribution within a gyroid-based heat exchanger without internal dividers, according to an embodiment.

FIG. 5 is a velocity magnitude visualization of flow distribution within a gyroid-based heat exchanger with internal dividers, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Heat exchangers play a significant role in a wide range of real-world applications, such as automotive thermal management, industrial process control, and HVAC systems, where efficient transfer of heat between two fluid streams is highly important. Conventional heat exchanger designs, including tube-and-fin arrangements, often face limitations in achieving uniform fluid distribution and optimal heat transfer, particularly as system demands increase. For example, in automotive battery cooling systems, uneven flow distribution can result in localized hot spots, reducing system reliability and efficiency. Recent advances have introduced gyroid-based structures, which offer improved surface-to-volume ratios and the ability to separate fluid domains within a compact volume. However, even with these advanced geometries, challenges remain in maintaining consistent flow across all regions, minimizing pressure losses, and accurately predicting performance in scenarios involving phase-change phenomena, such as refrigerant-based cooling. Attempts to address these issues, such as adding internal baffles or varying pore sizes, can complicate manufacturing or introduce undesirable pressure drops, limiting their practical effectiveness.

The present disclosure provides a technical solution that addresses these limitations by integrating internal dividers within the gyroid-based heat exchanger structure. These internal dividers are configured to partition each fluid flow domain into a plurality of discrete branches and to organize the branches such that corresponding branches in the first and second flow domains are arranged across the interfacial surface with fluid flow in opposite directions. In certain embodiments, the dividers and associated inlet and outlet placement cooperate to produce a cross-counter flow relationship in which a net direction of flow of a first fluid has a directional component from a first side face toward an opposite second side face and a directional component from a first end face toward an opposite second end face, while a net direction of flow of a second fluid has a directional component from the second side face toward the first side face and a directional component from the second end face toward the first end face, thereby maximizing heat exchange across the interfacial surface. The dividers may be arranged to inhibit lateral fluid communication within each domain, promoting uniform flow distribution and reducing the risk of stagnation or underutilized regions. In some embodiments, the gyroid structure and dividers are formed as a monolithic body, simplifying production and allowing for precise control over the internal geometry. This approach results in a heat exchanger that delivers improved thermal performance, manufacturability, and operational reliability in demanding real-world applications.

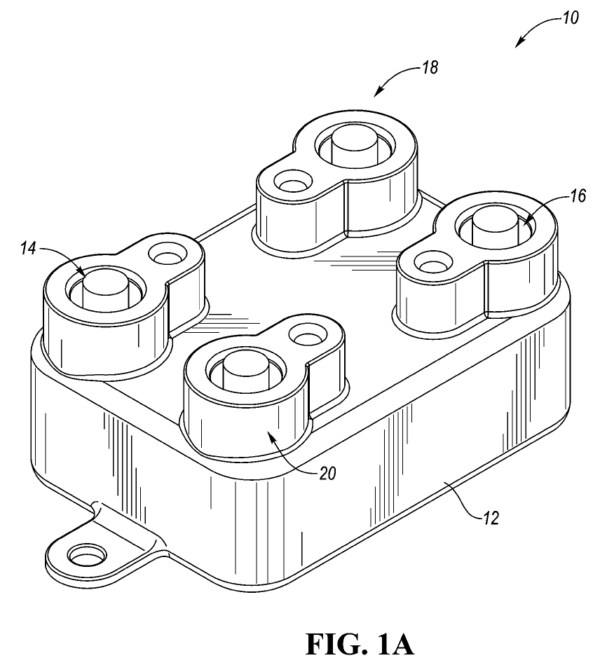

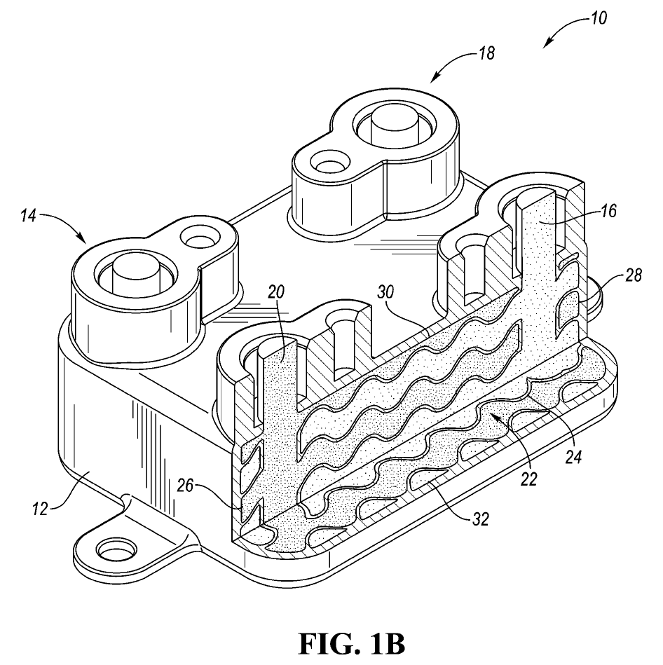

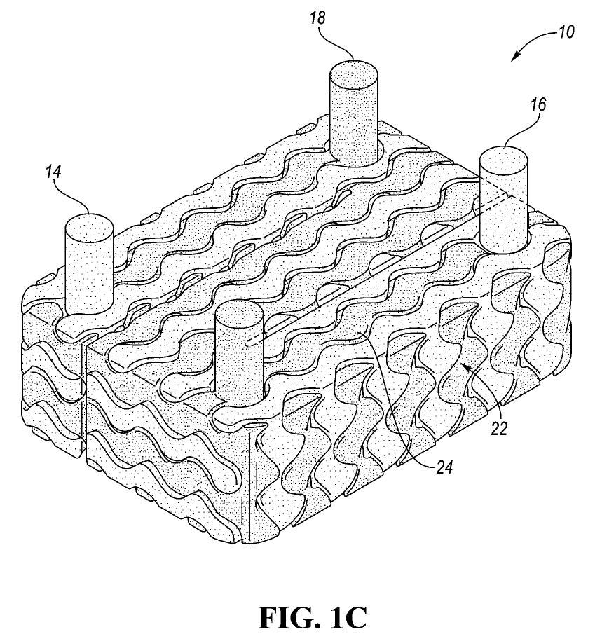

Referring to the Figures now, FIGS. 1A-1C show various views of an exemplary heat exchanger 10, wherein FIG. 1A shows the heat exchanger 10 from a perspective view, FIG. 1B shows a cross-sectional perspective view of the same heat exchanger 10, and FIG. 1C shows a perspective view of the heat exchanger 10 with the outer cover 12 removed and two different fluid flow paths illustrated with different shading to highlight the two different fluid flow domains.

Referring to FIGS. 1A-1C, the heat exchanger 10 includes an outer shell or cover 12 that houses and protects an internal heat exchange core. In certain embodiments, the cover 12 provides a sealed boundary around an interior region of the heat exchanger 10 and supports fluid coupling features for routing two working fluids through the heat exchanger 10 without mixing. The cover 12 may also provide structural support, mounting features, and sealing surfaces configured to withstand pressure and thermal cycling associated with operation of the heat exchanger 10.

The heat exchanger 10 includes a first inlet 14 and a first outlet 16 that are fluidly coupled to a first flow domain within the internal heat exchange core. The heat exchanger 10 further includes a second inlet 18 and a second outlet 20 that are fluidly coupled to a second flow domain within the internal heat exchange core. In certain embodiments, the first and second flow domains are non-mixing and are separated from one another by a continuous interfacial 24 surface of the internal core such that heat is transferred between the working fluids across the interfacial surface 24 while inhibiting direct fluid communication between the first and second flow domains. As illustrated schematically by the different shading in FIG. 1C, a first working fluid entering the heat exchanger 10 through the first inlet 14 is routed through the first flow domain toward the first outlet 16, while a second working fluid entering the heat exchanger 10 through the second inlet 18 is routed through the second flow domain toward the second outlet 20. In certain embodiments, the inlets 14, 18 and outlets 16, 20 are arranged such that the first working fluid and the second working fluid flow through respective portions of the internal core in generally opposite directions across the interfacial surface 24 to provide counter-flow heat exchange.

Referring to FIGS. 1B and 1C, the internal heat exchange core of the heat exchanger 10 comprises a gyroid core 22 that defines the first and second non-mixing flow domains. The gyroid core 22 may be formed as a triply periodic minimal surface structure defining a continuous interfacial surface 24 that separates two interpenetrating, labyrinthine volumes corresponding to the first flow domain and the second flow domain. In certain embodiments, the gyroid core 22 has a plurality of exterior boundary faces that define an outer boundary of the interior region of the heat exchanger 10, including opposing side faces and opposing end faces, and fluid flow through the first and second flow domains is routed between such boundary faces by the placement of the inlets 14, 18 and outlets 16, 20. The gyroid geometry may be selected to provide a desired surface-area-to-volume ratio, heat transfer coefficient, and pressure drop, and may also be selected to provide a desired minimum wall thickness and structural rigidity for the operating pressures of the working fluids.

In certain embodiments, the gyroid core 22 is manufactured using additive manufacturing techniques such that the gyroid geometry can be controlled and tuned during manufacture. For example, a unit cell size, a wall thickness, and a local porosity or hydraulic diameter of the gyroid structure may be varied as a function of position within the gyroid core 22 to achieve a desired balance of heat transfer performance, pressure drop, and mechanical strength. In certain embodiments, additive manufacturing further enables integration of internal flow-management features within the gyroid core 22, including features that define or shape flow paths within the first and second flow domains, while maintaining the continuous interfacial surface 24 separating the non-mixing flow domains.

During operation of the heat exchanger 10, a first working fluid is introduced to the first flow domain through the first inlet 14 and is discharged through the first outlet 16, while a second working fluid is introduced to the second flow domain through the second inlet 18 and is discharged through the second outlet 20. The first and second working fluids may be at different temperatures such that one of the working fluids is a relatively hotter fluid and the other working fluid is a relatively colder fluid. Heat is transferred between the first and second working fluids across the continuous interfacial surface 24 of the gyroid core 22 while inhibiting mixing of the working fluids.

In certain embodiments, the inlets 14, 18 and outlets 16, 20 are positioned to establish a cross-counter flow relationship between the first and second working fluids within the gyroid core 22. For example, a net direction of flow of the first working fluid through the first flow domain may have a directional component from a first side face 26 of the gyroid core 22 toward an opposite second side face 28 and a directional component from a first end face 30 toward an opposite second end face 32, while a net direction of flow of the second working fluid through the second flow domain may have a directional component from the second side face 28 toward the first side face 26 and a directional component from the second end face 32 toward the first end face 30. In other words, in the orientation shown in FIGS. 1B and 1C, the first working fluid flows generally from left to right and from top to bottom, while the second working fluid flows generally from right to left and from bottom to top. In this manner, the first and second working fluids may be routed so as to flow generally in opposite directions across the interfacial surface along each of two non-parallel directions, thereby increasing a temperature driving force across the interfacial surface throughout the gyroid core 22 and improving heat exchange performance.

In certain embodiments, at least one of the working fluids comprises a refrigerant and may undergo a phase change within the heat exchanger 10, including condensation and/or evaporation, depending on operating conditions. In such embodiments, the gyroid core 22 provides a high interfacial surface area for transferring latent and sensible heat between the working fluids while maintaining fluid isolation between the first and second flow domains. In other embodiments, both working fluids remain single-phase while exchanging heat across the interfacial surface.

In certain embodiments, the gyroid core 22 and its continuous interfacial surface 24 is a single, unitary (monolithic) body (e.g., formed via additive manufacturing or 3D printing) and is sealed relative to the cover 12 such that the first flow domain is in fluid communication with the first inlet 14 and the first outlet 16 and the second flow domain is in fluid communication with the second inlet 18 and the second outlet 20. In some embodiments, internal flow-management features are provided within the gyroid core 22 to influence flow distribution through the first and second flow domains, including internal dividers that partition at least one of the flow domains into a plurality of branches. As used herein, the side faces 26, 28 and end faces 30, 32 refer to boundary faces of the gyroid core 22 that define, at least in part, an outer boundary of the interior region in which flow occurs, rather than internal surfaces located within the flow domains or external surfaces facing away from the heat exchanger. In certain embodiments, such internal dividers may be continuous or may define openings, and one or more dividers may terminate short of a boundary face to permit limited lateral redistribution adjacent the boundary face. The internal dividers are shown generally in FIG. 1A, but are described in more detail below.

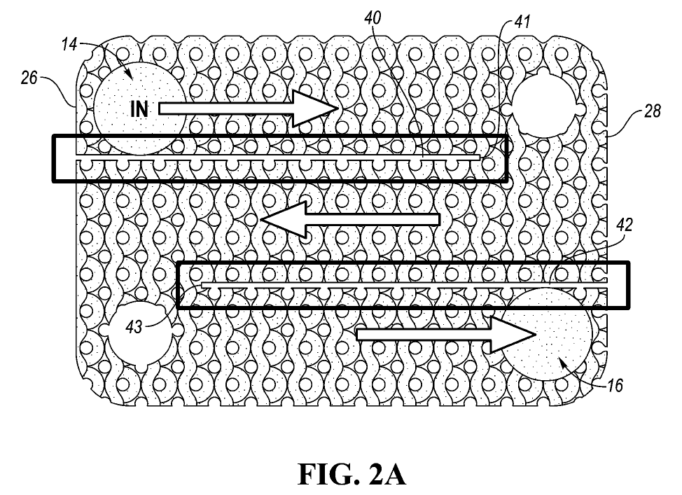

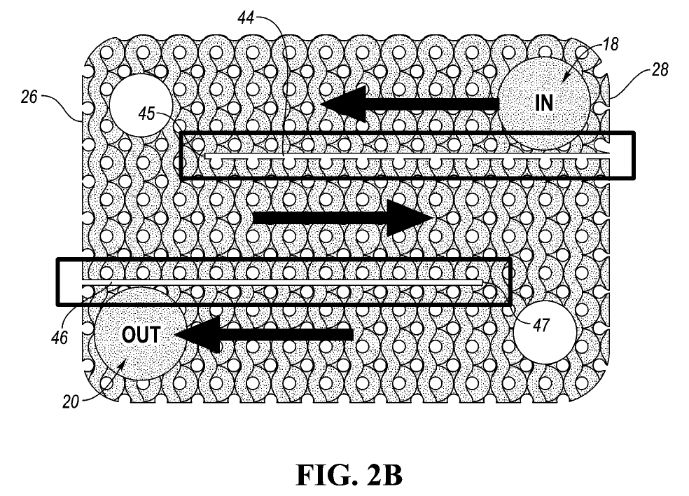

Referring now to FIGS. 2A and 2B, cross-sectional views of the heat exchanger 10 are shown taken along respective section planes through the gyroid core 22 to further illustrate how internal dividers may shape flow paths to achieve a cross-counter flow relationship. In FIGS. 2A and 2B, shaded regions generally represent flow passages (void volume) of a respective flow domain through which fluid is permitted to flow, while unshaded regions generally represent solid material of the gyroid core 22 (including divider structures) through which fluid flow is inhibited.

FIG. 2A illustrates an example of flow through a portion of the first flow domain between the first inlet 14 and the first outlet 16. As shown, a first internal divider 40 extends inwardly from the first side face 26 toward the second side face 28 and terminates short of the second side face 28. A second internal divider 42 extends inwardly from the second side face 28 toward the first side face 26 and terminates short of the first side face 26. The dividers 40, 42 are spaced apart so as to define a serpentine flow path in which fluid entering through the first inlet 14 is guided laterally toward the second side face 28 along a first run, redirected around a termination 41 of the first internal divider 40 to travel toward the first side face 26 along a second run while being bounded by the second internal divider 42, and redirected around a termination 43 of the second internal divider 42 to travel again toward the second side face 28 along a third run toward the first outlet 16. In this manner, the dividers 40, 42 inhibit lateral short-circuiting across the section and promote use of multiple laterally spaced regions of the first flow domain as the fluid traverses the gyroid core 22. The first flow domain may thus be subdivided by the internal dividers 40, 42 into successive branch regions through which the first working fluid passes in sequence.

FIG. 2B illustrates a corresponding example of flow through a portion of the second flow domain between the second inlet 18 and the second outlet 20. In FIG. 2B, a third internal divider 44 extends inwardly from the second side face 28 toward the first side face 26 and terminates at a termination 45 short of the first side face 26, and a fourth internal divider 46 extends inwardly from the first side face 26 toward the second side face 28 and terminates at a termination 47 short of the second side face 28. The dividers 44, 46 thereby define a serpentine flow path for the second working fluid that is laterally reversed relative to the serpentine flow path shown in FIG. 2A. In particular, fluid entering through the second inlet 18 is guided laterally along a first run while being bounded by the third internal divider 44, redirected around the termination 45 of the third internal divider 44 to pass into an adjacent laterally offset region of the second flow domain, guided along a second run in an opposite lateral direction while being bounded by the fourth internal divider 46, and redirected around the termination 47 of the fourth internal divider 46 to proceed along a third run toward the second outlet 20. The second flow domain may thus be subdivided by the internal dividers 44, 46 into successive branch regions through which the second working fluid passes in sequence. Throughout this routing, the second working fluid remains fluidly isolated from the first working fluid by the continuous interfacial surface 24.

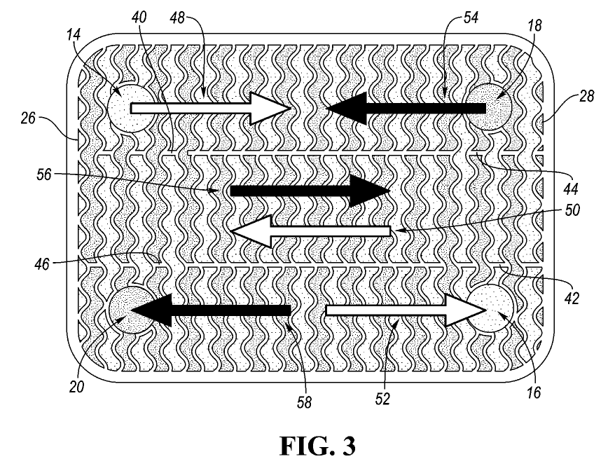

Referring now to FIG. 3, a further cross-sectional view of the gyroid core 22 is shown in which the first internal divider 40, the second internal divider 42, the third internal divider 44, and the fourth internal divider 46 are visible in a common section. FIG. 3 may be understood as illustrating, in a single slice through the heat exchanger 10, how divider structures associated with the first flow domain and divider structures associated with the second flow domain coexist within the monolithic gyroid core 22 while still maintaining fluid isolation between the two flow domains by the continuous interfacial surface 24. The differently shaded arrows shown in FIG. 3 schematically represent the respective flow paths of the first working fluid and the second working fluid through the slice, and may correspond to differently shaded or otherwise visually distinguished flow indicators in the drawings.

As shown in FIG. 3, the dividers are domain-specific in that a given divider is configured to obstruct and redirect flow within one flow domain without correspondingly obstructing the other flow domain at the same general location in the section. For example, near the second inlet 18, the third internal divider 44 extends from the second side face 28 such that it blocks passage of the second working fluid and redirects the second working fluid into a serpentine path. However, in another region of the same cross-section, such as near the first inlet 14, a corresponding obstruction by the third internal divider 44 is absent from the first flow domain (i.e., the third internal divider 44 stops short of the first side face 26), thereby permitting the first working fluid to occupy and traverse that region. Similarly, the first internal divider 40 and the second internal divider 42 are arranged to shape flow in the first flow domain without identically blocking the second flow domain at those same laterally corresponding locations, and the fourth internal divider 46 is arranged to shape flow in the second flow domain without identically blocking the first flow domain at the same location. In this manner, the divider structures may be integrated into the monolithic gyroid core 22 such that each divider acts within its intended flow domain while the other flow domain remains separately open in adjacent or corresponding portions of the section.

In the embodiment shown, the domain-specific divider arrangement partitions the first flow domain into a plurality of first branches 48, 50, 52 and partitions the second flow domain into a plurality of second branches 54, 56, 58. As used herein, a “branch” refers to a portion of a respective flow domain that is bounded, at least in part, by one or more of the internal dividers and by a boundary face of the gyroid core 22, and through which the working fluid flows along a respective run before being redirected around a divider termination into another branch. Thus, in the view of FIG. 3, the first working fluid may be routed successively through the first branches 48, 50, 52, while the second working fluid may be routed successively through the second branches 54, 56, 58 in a laterally reversed manner. Corresponding ones of the first branches 48, 50, 52 and the second branches 54, 56, 58 may be arranged across the continuous interfacial surface 24 such that the first and second working fluids flow with opposite directional components in the corresponding branches, thereby providing branch-wise counter flow within the overall cross-counter flow arrangement.

FIG. 3 therefore further illustrates how the first working fluid may follow a first serpentine path between the first inlet 14 and the first outlet 16 through the first branches 48, 50, 52, while the second working fluid may follow a second serpentine path between the second inlet 18 and the second outlet 20 through the second branches 54, 56, 58 in a laterally reversed manner. Although the arrows in FIG. 3 show the serpentine routing in the plane of the illustrated section, the respective fluids may also simultaneously progress through the thickness of the gyroid core 22 between the first end face 30 and the second end face 32, as described above, such that the overall flow relationship remains a cross-counter flow arrangement. Thus, FIG. 3 demonstrates that the internal divider arrangement can partition the respective flow domains into separate branches, redirect each fluid multiple times across the width of the gyroid core 22, and maintain opposed directional components of flow across the continuous interfacial surface 24 to enhance heat transfer.

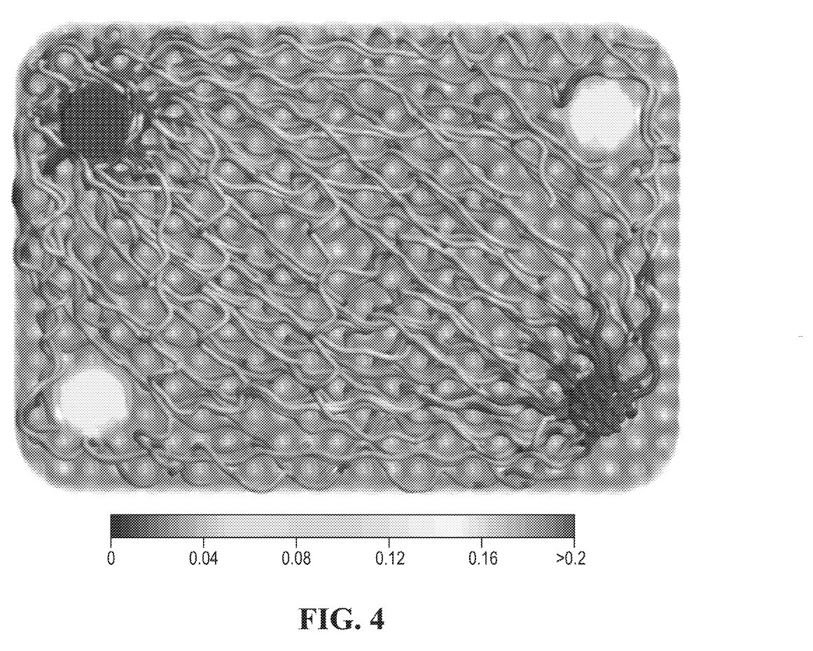

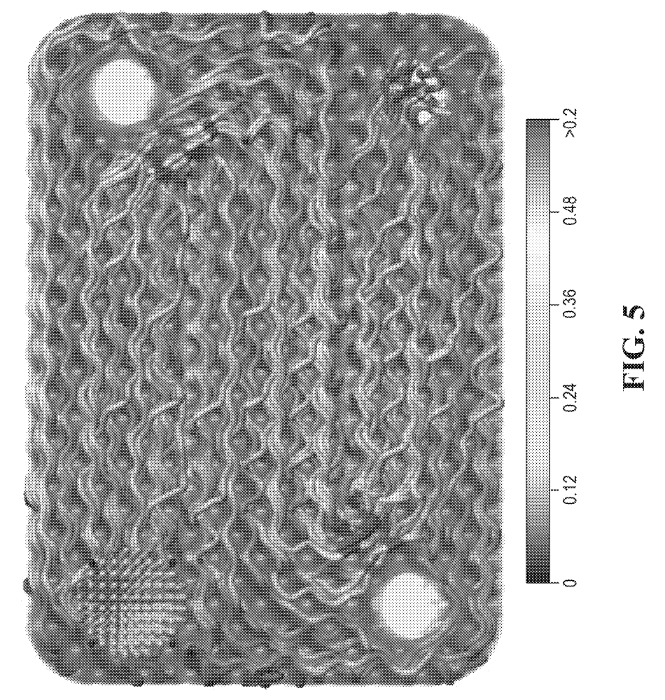

Referring now to FIGS. 4 and 5, these figures illustrate comparative velocity-magnitude visualizations for a gyroid-based heat exchanger in order to show the effect of the disclosed divider arrangement on flow distribution through the core. FIG. 4 represents flow behavior in a gyroid heat exchanger without the disclosed internal dividers, whereas FIG. 5 represents flow behavior in a corresponding gyroid heat exchanger in which internal dividers are provided to create the serpentine, branch-wise flow paths described above. In each figure, the visualization indicates relative flow velocity within the available flow passages, such that some regions exhibit comparatively higher local velocity and other regions exhibit comparatively lower local velocity.

As shown in FIG. 4, in the absence of the dividers, the flow tends to follow more direct or preferential paths through the gyroid core between the fluid ports, with relatively concentrated high-velocity regions occurring along selected flow routes and relatively lower-flow regions remaining elsewhere in the core. Stated differently, portions of the available gyroid volume are used more heavily than others, such that the flow distribution is less uniform throughout the heat exchanger. This type of uneven flow distribution can reduce effective utilization of the available interfacial heat-transfer area because portions of the core experience comparatively little fluid movement.

By contrast, FIG. 5 shows that, when the internal dividers are present, the flow is redistributed through the gyroid core in a more controlled and more uniform manner. The dividers force the fluid to traverse multiple branches and to follow a serpentine path rather than short-circuiting more directly between the inlet and outlet. As a result, the flow extends through a greater portion of the core volume, and the velocity distribution is spread more broadly across the heat exchanger. In this manner, the divider-based configuration can force flow throughout the core, reduce lower-flow areas, and increase the portion of the gyroid interfacial surface that actively participates in heat exchange.

FIGS. 4 and 5 therefore demonstrate a technical benefit of the disclosed divider arrangement. By improving uniformity of flow through the gyroid core and by ensuring that the fluid is routed through multiple branches, the dividers can increase effective heat rejection area and improve the heat-transfer condition between the two fluid domains. In embodiments in which corresponding branches of the two domains are arranged for counter flow, the dividers can also help maintain counter flow in each branch, thereby supporting a more favorable temperature driving force across the interfacial surface over a larger portion of the core. Accordingly, the divider-equipped gyroid structure shown in FIG. 5 can provide improved thermal performance relative to the undivided gyroid structure shown in FIG. 4.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A heat exchanger comprising:
a monolithic gyroid core defining a continuous interfacial surface that separates two non-mixing flow domains including a first flow domain and a second flow domain, the gyroid core having (i) a first side face and an opposite second side face and (ii) a first end face and an opposite second end face;
a first inlet and a first outlet fluidly coupled to the first flow domain; and
a second inlet and a second outlet fluidly coupled to the second flow domain;
a first set of internal dividers disposed within the first flow domain and configured to partition the first flow domain into a plurality of first branches extending from the first inlet to the first outlet;
a second set of internal dividers disposed within the second flow domain and configured to partition the second flow domain into a plurality of second branches extending from the second inlet to the second outlet; and
wherein the first and second sets of internal dividers are arranged such that corresponding first and second branches are arranged across the interfacial surface with flow in opposite directions;
wherein the first inlet and the first outlet are positioned relative to the gyroid core such that a net direction of flow of a first fluid through the first flow domain from the first inlet to the first outlet has a first directional component from the first side face toward the second side face and a second directional component from the first end face toward the second end face; and
wherein the second inlet and the second outlet are positioned relative to the gyroid core such that a net direction of flow of a second fluid through the second flow domain from the second inlet to the second outlet has a directional component from the second side face toward the first side face and a directional component from the second end face toward the first end face, thereby providing cross-counter flow heat exchange across the interfacial surface.

2. The heat exchanger of claim 1, wherein each internal divider of the first set and the second set is integral with the monolithic gyroid core.

3. The heat exchanger of claim 1, wherein each internal divider of the first set and the second set extends between (i) a first flow face defining a portion of the first flow domain and (ii) an opposite second flow face that defines a portion of the second flow domain.

4. The heat exchanger of claim 1, wherein the first set of internal dividers partitions the first flow domain into at least three first branches, and wherein the second set of internal dividers partitions the second flow domain into at least three second branches.

5. The heat exchanger of claim 1, wherein at least one internal divider of the first set defines a plurality of openings configured to permit limited lateral fluid communication within the first flow domain.

6. The heat exchanger of claim 5, wherein at least one internal divider of the second set defines a plurality of openings configured to permit limited lateral fluid communication within the second flow domain.

7. The heat exchanger of claim 1, wherein the first set of internal dividers and the second set of internal dividers are positioned to align the plurality of first branches and the plurality of second branches in alternating order across the interfacial surface.

8. The heat exchanger of claim 1, wherein the first set of internal dividers includes (i) a first internal divider that extends inwardly from a first side face of the gyroid core toward an opposite second side face of the gyroid core and terminates short of the second side face and (ii) a second internal divider that extends inwardly from the second side face toward the first side face and terminates short of the first side face.

9. The heat exchanger of claim 1, wherein the second set of internal dividers includes (i) a third internal divider that extends inwardly from the second side face toward the first side face and terminates short of the first side face and (ii) a fourth internal divider that extends inwardly from the first side face toward the second side face and terminates short of the second side face.

10. A heat exchanger comprising:
a gyroid core defining a continuous interfacial surface that separates a first flow domain and a second flow domain that are fluidly isolated from one another to inhibit mixing of fluids flowing through the first and second flow domains, the gyroid core having a first side face and an opposite second side face and a first end face and an opposite second end face;
a first inlet and a first outlet fluidly coupled to the first flow domain;
a second inlet and a second outlet fluidly coupled to the second flow domain;
a first set of internal dividers disposed within the first flow domain, wherein the first set of internal dividers is configured to inhibit lateral fluid communication within the first flow domain through at least a portion of a thickness of the gyroid core; and
a second set of internal dividers disposed within the second flow domain, wherein the second set of internal dividers is configured to inhibit lateral fluid communication within the second flow domain through at least a portion of the thickness of the gyroid core;
wherein the first inlet and the first outlet are arranged such that a net direction of flow through the first flow domain has a first directional component from the first side face toward the second side face and a second directional component from the first end face toward the second end face; and
wherein the second inlet and the second outlet are arranged such that a net direction of flow through the second flow domain has a directional component from the second side face toward the first side face and a directional component from the second end face toward the first end face, thereby providing cross-counter flow heat exchange across the interfacial surface.

11. The heat exchanger of claim 10, wherein the first set of internal dividers partitions the first flow domain into a plurality of first branches, each first branch extending from the first inlet toward the first outlet.

12. The heat exchanger of claim 11, wherein the second set of internal dividers partitions the second flow domain into a plurality of second branches, each second branch extending from the second inlet toward the second outlet.

13. The heat exchanger of claim 12, wherein the first and second sets of internal dividers are arranged such that, for each of the plurality of first branches, a corresponding one of the plurality of second branches is disposed immediately across the interfacial surface and oriented so that fluid flow through the corresponding branches is in opposite directions across the interfacial surface.

14. The heat exchanger of claim 13, wherein at least one internal divider of the first set of dividers extends through an intermediate portion of the thickness of the gyroid core and terminates short of an exterior face of the gyroid core that defines a boundary of the first fluid flow, such that limited lateral redistribution is permitted adjacent the exterior face.

15. The heat exchanger of claim 14, wherein at least one internal divider of the second set of dividers extends through another intermediate portion of the thickness of the gyroid core and terminates short of an exterior face of the gyroid core that defines a boundary of the second fluid flow, such that limited lateral redistribution is permitted adjacent the exterior face.

16. The heat exchanger of claim 13, wherein at least one of the plurality of first branches has a different flow cross-sectional area than another of the plurality of first branches to apportion flow among the plurality of first branches.

17. The heat exchanger of claim 13, wherein at least one of the plurality of second branches has a different flow cross-sectional area than another of the plurality of second branches to apportion flow among the plurality of second branches.

18. The heat exchanger of claim 13, wherein the first set of internal dividers and the second set of internal dividers are non-identical in at least one of divider count, divider spacing, or divider thickness to provide different hydraulic resistance characteristics in the first flow domain than in the second flow domain.

19. The heat exchanger of claim 11, wherein the first set of internal dividers are planar, and the second set of internal dividers are planar.

20. A 3D-printed heat exchanger comprising:
a monolithic gyroid core defining a continuous interfacial surface that separates two non-mixing flow domains including a first flow domain and a second flow domain, the gyroid core having a first side face at an extremity of an interior of the heat exchanger and an opposite second side face at another extremity of the interior of the heat exchanger;
a first inlet and a first outlet fluidly coupled to the first flow domain;
a second inlet and a second outlet fluidly coupled to the second flow domain;
a first set of internal dividers disposed within the first flow domain, the first set of internal dividers including at least a first internal divider and a second internal divider that are spaced apart from one another, the first internal divider extending inwardly from the first side face toward the second side face and terminating short of the second side face, and the second internal divider extending inwardly from the second side face toward the first side face and terminating short of the first side face such that the first set of internal dividers defines a plurality of first branches in the first flow domain between the first inlet and the first outlet; and
a second set of internal dividers disposed within the second flow domain, the second set of internal dividers including at least a third internal divider and a fourth internal divider that are spaced apart from one another, the third internal divider extending inwardly from the second side face toward the first side face and terminating short of the first side face, and the fourth internal divider extending inwardly from the first side face toward the second side face and terminating short of the second side face, such that the second set of internal dividers defines a plurality of second branches in the second flow domain between the second inlet and the second outlet;
wherein the first and second sets of internal dividers are arranged such that at least one of the plurality of first branches is disposed immediately across the interfacial surface from at least one of the plurality of second branches and is configured for counter-flow heat exchange across the interfacial surface.
